(19) United States
(12) Patent Application Publication
(10) Pub. No.: US 2024/0026136 A1
(43) Pub. Date: Jan. 25, 2024

(54) Fiber And Blended Polymers In Composite With Modulus, Heat Resistance, and Impact Strength

(71) Applicant: Tundra Composites, LLC, White Bear Lake, MN (US)

(72) Inventors: Kurt Heikkila, Marine on the St. Croix, MN (US); Michael Deaner, Osceola, WI (US)

(73) Assignee: Tundra Composites, LLC, White Bear Lake, MN (US)

(21) Appl. No.: 17/872,233

(22) Filed: Jul. 25, 2022

(51) Int. Cl. C08L 23/28; C08L 27/06

(52) U.S. Cl. CPC C08L 23/286; C08L 27/06; C08L 2310/00

(57) ABSTRACT

The claimed material relates to a composite of an interfacial modified fiber and mixed or combined polymer composite having enhanced impact, and modulus properties.

### FIELD

Disclosed is a composite of a modified fiber and a polymer blend. The composite has improved heat stability, modulus, and impact to produced enhanced products. The novel properties are produced in the composite by novel interactions of the coated modified fiber and polymeric blend components.

### BACKGROUND

Composite materials have been used in structural articles for many years. Structural articles including composite materials have been used as decking, stair treads, ladder rungs and other components requiring substantial stiffness, tensile and modulus properties. We have found that the important properties for such structural members include substantial impact strength, tensile properties, and modulus such that these structural members can survive hard use in the external or built environment to avoid structural distortion, harm, failure etc. To achieve significant useful lifetime while used in the built environment, the structural member must have substantial tensile modulus and impact properties. Few materials currently available have more than one or two of the important structural capacity. As a result, the conventional structural members can fail due to surface abrasion or fracturing, failure of the structural member to maintain an adequate fastener connection, resist substantial flexion or breakage and other problems resulting from the failure of the structural member to have a significant flexural strength or impact strength. Many chlorine containing impact modifiers have been suggested in the commercial products but have not succeeded in producing a successful structural members.

A substantial need in the composite materials used in structural members exist in optimizing composite materials in structural applications having a combination of substantially increased modulus, increased impact strength, and improved heat stability.

### BRIEF DESCRIPTION

We have found a substantially improved composite for use in structural members that due to the combination of unique ingredients including a combination of a thermoplastic polymer comprising vinyl chloride, a chlorinated polyethylene polymer, and a blended or mixed organo metallic interfacial modified reinforcing fiber when fashioned into a structural member obtains significant improvements in functional lifetime in the built environment. Such a composite of a modified fiber and a polymer has improved and novel impact, heat stability, and modulus. The claimed composite is made of a combination of a thermoplastic PVC polymer, a chlorinated polyethylene (CPE) and blended or mixed organo metallic interfacial modified fiber (a fiber with a substantially complete coating of an interfacial modifier (IM) with a coating thickness of less than 1000 often less than 200 Angstroms (Å)). The composite properties result from a selection of fiber type and size, polymer blend, molecular weights, IM and blends, viscoelastic character, and processing conditions. The cooperative interaction of the coated fiber with the CPE in the PVC composite keep excellent modulus but add substantially to impact properties. The resulting composite materials exceed the contemporary structural composites in packing, surface inertness, processability, impact resistance, heat stability and modulus. In the process of making the composite, the fiber input to the compounding process unit can have an arbitrary length, often about 0.8 to 100 mm. The product output of the compounding process unit can have a fiber of similar length, depending on process conditions. The fiber can be reduced in length if sheared in compounding. The composite containing the fiber can be pelletized. In the pellet, the fiber cannot be longer than the major dimension of the pellet.

One aspect of the claimed material is a composite of blended or mixed organo metallic interfacial modifier coated fiber and combined polymers. A mixed metal interfacial modifier can include two separate modifier compounds or one modifier compound with mixed metals in the central atom.

Another aspect is a structural member made of the composite. Such structural members can be used in decking, fenestration units including windows and doors in commercial and other structures requiring impact strength and modulus residential construction.

Still another aspect is a pellet that can be used as an intermediate between the compounding of the composite and the manufacturing of the final product. The pellet can be made of the composite and can be formed as the composite is compounded. As the composite is formed and extruded from the compounder the pellet can be cut into pellets useful in thermoplastic part manufacture. Pellets are typically about 2 to 20 mm in length and about 3 to 25 mm in maximum cross-sectional dimension. In a cylindrical pellet the diameter can be about 3 to 20 mm.

A final aspect is a method of compounding into a master batch, a composite, a pellet, or a composite structural member. The composite by compounding the combined polymer resin and interfacial modified fiber under thermoplastic conditions.

The term “blended polymer” means a combination of a thermoplastic polymer comprising vinyl chloride and a chlorinated polyethylene (CPE) polymer. Typical commercial CPE polymers have a chlorine content less than 50 wt. % while PVC and chlorinated PVC have a chlorine content greater than 55 wt. %.

The term “fiber” means a fibrous material input to a compounding process unit. The useful, glass fiber material has a cross-section dimension (preferably but not limited to a diameter) of at least about 0.8 micron often about 1-150 microns and can be 2-100 microns a length of 0.1-150 mm, often 0.2-100 mm, and often 0.3-20 mm and can have an aspect ratio of at least 90 often about 100-1500. These aspect ratios are typical if the input is to the compounder. After pellets are formed the aspect ratio is set by the pellet dimensions. “Fiber” can be free of a particle or particulate component.

The term as used in this disclosure the term “interfacial modifier” means an organo metallic material that can coat the surface of fiber and does not react with the polymer or other fiber present in the composite. In one embodiment the material is an organo-metallic material.

The term “inorganic filler” means a conventional inorganic composition comprising, for example, a clay, a carbonate, a silicate, or an aluminate such as talc, mica, CaCO₃, Kaolin, CaSO₄ or Al₂O₃·H₂O.

The term “pellet” is a composite object that is typically about 2 to 20 mm in length and about 3 to 25 mm in maximum cross-sectional dimension. In a cylindrical pellet the diameter can be about 3 to 10 mm.

The term “master batch” refers to a thermoplastic composite having increased amounts of glass fiber (typically greater than 50 wt. % fiber) components in a polymer phase that can be combined and diluted with additional polymer to the final use concentrations of the composite components as used in a product

The term “member” means a structural member.

### BRIEF DESCRIPTION OF THE FIGURE

FIG. 1 shows a cross section of a typical structural member of the disclosure.

### DETAILED DISCUSSION

Novel composites can be made by a combination of CPE and PVC polymers with an interfacial modified fiber to achieve novel physical and process properties including impact, heat stability, and modulus. A combination of a thermoplastic polymer and a chlorinated polyethylene (CPE) can be used.

Chlorinated polyethylene (CPE) is made by chlorinating polyethylene polymer materials. The chlorinated polyethylene polymer properties depend on the properties of the starting polymer material and the amount of, and distribution of the chlorination produced. In the chlorination of polyethylene, a chlorine atom is substituted randomly for a hydrogen atom on the polymer chain accompanied by the formation of hydrochloric acid (HCl). This occurs in a free radical mechanism, usually catalyzed by UV light or other high energy initiators. The chlorination process of the polymer chain involves solvent based and solvent-less or anhydrous processing. Commercial chlorinated polyethylene has a chlorine content that can range from 20 to 50%. Higher molecular weight and linear polyethylene yields a chlorinated polyethylene with a higher viscosity and tensile properties. The chlorine content can influence tensile properties, flexibility, et cetera.

Chlorinated polyethylene (CPE) is different from polyvinyl chloride (PVC and C-PVC). PVC is polymerized typically from mostly vinyl chloride monomers yielding polymer blocks of a regular but alternating array of chlorine atoms on a polymer backbone. Most commercial PVC materials are vinyl chloride homopolymers. Chlorinating PVC can make C-PVC. CPE is made from a polyethylene polymer (PE) containing mostly ethylene monomers. CPE is randomly chlorinated to form random chlorine atom substitutions replacing hydrogen atoms on the polymer backbone.

A large variety of thermoplastic homopolymer and copolymer materials can be combined with the chlorinated polyethylene (CPE) used in the composite materials. We have found that polymer materials useful in the composite include both condensation polymeric materials and addition or vinyl polymeric materials. Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation. The typical polymer has a density of at least 0.85 gm-cm⁻³, however, polymers having a density of greater than 0.96 are useful to enhance overall product density. A density is often up to 1.7 or up to 2 gm-cm⁻³ or can be about 1.5 to 1.95 gm-cm⁻³.

Vinyl polymers include polyacrylonitrile; polymer of alpha-olefins such as ethylene, propylene, etc.; polymers of chlorinated monomers such as vinyl chloride, vinylidene chloride, can be used to make PVC, C-PVC; polymers form acrylate monomers such as acrylic acid, methyl acrylate, methyl methacrylate, acrylamide, hydroxyethyl acrylate, and others; styrenic monomers such as styrene, alpha-methyl styrene, vinyl toluene, etc.; vinyl acetate; and other commonly available ethylenically unsaturated monomer compositions. Examples include polyethylene, polypropylene, polybutylene, acrylonitrile-butadiene-styrene (ABS), polybutylene copolymers, polyacetal resins, polyacrylic resins, homopolymers or copolymers comprising vinyl chloride, vinylidene chloride, fluorocarbon copolymers, such as PVC and C-PVC etc.

Commercial exterior weathering compounded PVC compound are formed by the incorporation of additives (but not necessarily all of the following) such as heat stabilizers, UV stabilizers, plasticizers, processing aids, impact modifiers, thermal modifiers, fillers, flame retardants, biocides, blowing agents and smoke suppressors, and pigments. The choice of additives used for the PVC finished product is controlled by the cost performance requirements of the end use specification (underground pipe, window frames, intravenous tubing and flooring all have quite different ingredients to suit their environmental performance requirements).

Condensation polymers include nylon, phenoxy resins, polyarylether such as polyphenylether, polyphenylsulfide materials; polycarbonate materials, chlorinated polyether resins, polyethersulfones resins, polyphenylene oxide resins, polysulfone resins, polyimide resins, thermoplastic urethane elastomers and many other resin materials. Condensation polymers that can be used in the composite materials include polyamides, polyamide-imide polymers, polyarylsulfones, polycarbonate, polybutylene terephthalate, polybutylene naphthalate, polyetherimides, polyether sulfones, polyethylene terephthalate, thermoplastic polyamides, polyphenylene ether blends, polyphenylene sulfide, polysulfones, thermoplastic polyurethanes and others. Preferred condensation engineering polymers include polycarbonate materials, polyphenylene oxide materials, and polyester materials including polyethylene terephthalate, polybutylene terephthalate, polyethylene naphthalate and polybutylene naphthalate materials.

Useful fiber includes both natural and synthetic fibers. Claimed composites are free of particulate such as inorganic fillers. Natural fiber includes those of animal or plant origin. Plant based examples include cellulosic materials such as wood fiber, cotton, flax, jute, cellulose acetate etc.; animal-based materials made of protein include wool, silk etc. Synthetic fibers include polymer materials such as acrylic, aramid, amide-imide, nylon, polyolefin, polyester, polyurethane, carbon, etc.

Other types include glass, metal, or ceramic fibers. Metallic fibers are manufactured fibers of metal, metal coated plastic, or a core completely covered by metal. Non-limiting examples of such metal fibers include gold, silver, aluminum, stainless steel, and copper. The metal fibers may be used alone or in combinations. The determinant for the selection metal fiber is dependent on the properties desired in the composite material or the shaped article made therefrom.

One useful fiber comprises a glass fiber known by the designations: A, C, D, E, Zero Boron E, ECR, AR, R, S, S-2, N, and the like. Generally, any glass that can be made into fibers either by drawing processes used for making reinforcement fibers or spinning processes used for making thermal insulation fibers. Such fiber is typically used as a length of about 0.8-100 mm often about 2-100 mm, a diameter about 0.8-100 microns and an aspect ratio (length divided by diameter) greater than 90 or about 100 to 1500.

These commercially available fibers are often combined with a sizing coating. Such coatings cause the otherwise ionically neutral glass fibers to form and remain in bundles or fiber aggregates. Sizing coatings are applied during manufacture before gathering. The sizing minimizes filament degradation caused by filament-to-filament abrasion. A commercial sizing is not an interfacial modifier and can be lubricants, protective, or reactive couplers but do not contribute to the properties of a composite using an interfacial modifier coating on the fiber surface.

The fiber is typically coated with an interfacial surface chemical treatment also called an interfacial modifier (IM) or mixtures thereof. An IM supports or enhances the final properties of the composite such as modulus, impact strength, heat stability, viscoelasticity, rheology, high packing fraction, and fiber surface inertness. These properties are not present in commercial contemporary composite materials.

An interfacial modifier is an organo-metallic material, or mixture thereof, provides an exterior coating on the fiber promoting the close association, but not attachment or bonding, of polymer to fiber and fiber to fiber. An interfacial moodier is a compound with a central atom and a set of ligands surrounding the atom. The composite properties arise from the intimate association of the polymer, CPE and fiber obtained by use of careful processing and manufacture. An interfacial modifier is in part an organic material, in some examples an organo-atomic or organo-metallic material, that provides an exterior coating on the fiber to provide a surface that can associate, but does not react, with the polymer promoting the close association of polymer and fiber but with no reactive bonding, such as covalent bonding for example, of polymer to fiber, fiber to fiber, or fiber to a different particulate, such as a glass fiber. In one embodiment, the coating of interfacial modifier at least partially covers the surface of the fiber. In another embodiment, the coating of interfacial modifier continuously and uniformly covers the surface of the fiber, in a continuous coating phase layer

Interfacial modifiers used in the application fall into broad categories of organo metallic compounds including, for example, titanate compounds, zirconate compounds, hafnium compounds, samarium compounds, strontium compounds, neodymium compounds, yttrium compounds. Useful IM ligands contain from about 1 to about 4 ligands. A variety of ligand on the central atom can be used. Ligand “Alkyl” or “alkyl groups” as means a branched or unbranched saturated hydrocarbon group of 1 to 100 carbon atoms, preferably 1 to 30 carbon atoms, such as methyl, ethyl, n-propyl, isopropyl, n-butyl, isohutyl, t-butyl, octyl, letradecyl, hexaderyt, eicosyl, letracosyl and the like, as well as cycloalkyt groups such as cyclopentyl, cyclohexyl and the like. Optionally, an alkyl can contain 1 to 6 linkages selected from the group consisting of —O—, —S—, -M- and —NR— where R is hydrogen, or C₁-C₈ alkyl or lower alkenyl. In addition to the alkyl groups identified herein, other possible alkyl groups can be used in the practice of the described methods.

Various organic ligands can be used. Acidic and basic compounds can be used. Oxoacids can be used. Oxoacid means an acid that includes oxygen, at least one element other than oxygen, at least one hydrogen atom bound to oxygen, and forms an ion upon loss of one or more protons. Examples include carboxylic acids, sulfuric acid, nitric acid, phosphoric acid, and halogen-containing oxoacids, such as hypochlorous acid, chlorous acid, chloric acid, perchloric acid, etc. Others, for example, are P(OH)₃, RC(═O)OH, HOSOH, HOCl, HON═O, (HO)₂SO₂, R(═O)(OH)₂. Others can lose a positive hydrogen ion(s) and become mildly basic. Other acids include conjugate bases, salts, or esters. Others include n-allyl cadmium phosphonate, n all yl zinc phosphonate, n-alkyl cadmium carboxylate, n-alkyl zinc carboxylate and the like. In some embodiments, the n-alkyl portion of the phosphonate can be any hydrocarbon compound (e.g., alkanes, alkenes, and alkynes of which any can be linear, branched, or cyclic). Esters thereof are useful that include at least one hydroxyl group that has been replaced by an alkyl (alkoxy) group. Exemplary phosphonic acid compounds include alkyl phosphonic acid compounds, such as, for example, C₁-C20 alkyl phosphonic acid compounds, where the alkyl group can be linear or branched (e.g., tetradecyl phosphonic acid, methyl phosphonic acid, ethyl phosphonic acid, butyl phosphonic acid, hexyl phosphonic acid, octyl phosphonic acid, and the like).

Other suitable alkoxy groups can include a R—O— group. Suitable ligands include C₁-C₂₀ groups, where the alkyl group can be linear or branched (e.g., lauric, myristic palmitic and stearic acetic, propionic, butyric, hexanoic, and octanoic). In some embodiments, a mixture of at least one C₄-C₁₂ group and at least one C₁-C₁₀ group can be used. In certain embodiments, a mixture of two alkyl group compounds is used. For example, a first alkyloxy compound can be selected from C₁-C₁₀ alkoxy compounds and a second carboxylic acid compound can be selected from C₁₀-C₂₀ alkyl carboxylic acid compounds

Ligands comprising hydrocarbyl phosphate esters and/or hydrocarbyl sulfonate esters and about 1 to 4 hydrocarbyl oxy acids or alkoxy groups ligands which may further contain unsaturation and heteroatoms such as oxygen, nitrogen, and sulfur. The specific type of organo-titanate, organo-aluminates, organo-strontium, organo-neodymium, organo-yttrium, organo-zirconates which can be used, and which be referred to as organo-metallic compounds in an embodiment can have at least one hydrolysable group, at least one organic moiety, or a hetero organic moiety with P, S or N atoms. Mixtures or blends of the organo-metallic interfacial modifiers materials can be used. The mixture of the interfacial modifiers may be applied inter- or intra-fiber, which means at least one of the fibers can have more than one interfacial modifier coating the surface (intra), or more than one interfacial modifier coating may be applied to different fibers or fiber size distributions. Minimal amounts of the modifier can be used including about 0.005 to 8 wt.-%, about 0.02 to 6.0, wt. %, about 0.02 to 3.0 wt. %, about 0.02 to 4.0 wt. % or about 0.02 to 5.0 wt. %.

TABLE 1
Typical Formulations

| Component | Useful wt. % | Useful wt. % |
|---|---|---|
| Chlorinate Polyethylene | 10 to 35 | 15 to 25 |
| Polymer | 35 to 75 | 50 to 70 |
| Fiber | 35 to 75 | 50 to 70 |
| Interfacial modifier | 0.1 to 5 | 1 to 4 |
| based on fiber | | |

TABLE 2
Typical Formulations

| Component | Useful wt. % | Useful wt. % |
|---|---|---|
| Chlorinate Polyethylene | 10 to 35 | 15 to 25 |
| PVC Polymer | 35 to 75 | 50 to 70 |
| Fiber | 35 to 75 | 50 to 70 |
| Interfacial modifier | 0.1 to 5 | 1 to 4 |
| based on fiber | | |

TABLE 3
Typical Formulations

| Component | Useful wt. % | Useful wt. % |
|---|---|---|
| Chlorinate Polyethylene | Balance | Balance |
| Polymer | 3 to 10 | 4 to 8 |
| Glass Fiber | 5 to 10 | 6 to 9 |
| Interfacial modifier | 0.1 to 5 | 0.2 to 3 |
| (based on fiber) | | |

TABLE 4
Typical Formulations

| Component | Useful wt. % | Useful wt. % |
|---|---|---|
| Chlorinated Polyethylene | Balance | Balance |
| PVC Polymer | 3 to 10 | 4 to 8 |
| Glass Fiber | 5 to 10 | 6 to 9 |
| Interfacial modifier | 0.1 to 5 | 0.2 to 3 |
| (based on fiber) | | |

TABLE 5
Composite Typical Properties

| | | Useful | Workable | |
|---|---|---|---|---|
| | | value @ 20 wt. | Value @ 6 wt. | |
| Property | Method | % Glass Fiber | % Glass Fiber | Units |
| Flexural | D790 | >0.5 | >0.4 | Mpsi |
| Modulus | | | | |
| Heat | As | >250 | >50 | Hours @ |
| Deflection | described | | | 143° F. |
| Room | ASTM | >100 | >300 | in-lb.-in⁻¹ |
| Temp | D4226 | | | |
| Impact | | | | |
| COTE | D6341 | <2.0 × 10⁻⁵ | <3.0 × 10⁻⁵ | in/in/° F. |

### EXPERIMENTAL SECTION

### Examples 1 to 3

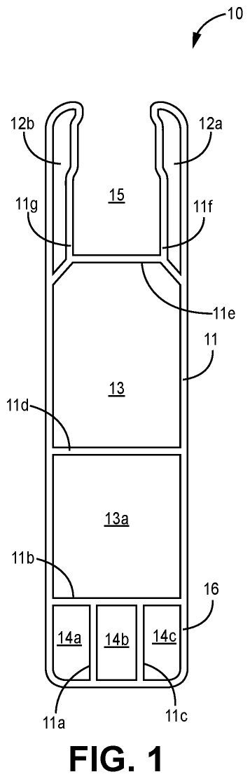

An amount of an exterior weathering compounded PVC including 3.5 phr of an acrylic shell and a core impact modifier was fed to a twin screw extruder, with a 60 wt. % glass fiber/20 w. % PVC/20 Wt. % CPE masterbatch. The glass fiber coated with 1.48 wt. % of a mixed organometallic interfacial modifier. The ratios PVC to masterbatch was controlled to achieve a design amount in 0, 6, 7, and 12 wt. % glass fiber in examples 1 to 3 of the composite final. product. The blend was extruded into the fence rail profile like that of FIG. 1 at 190° C. and 500 lb./hr. with a cap of 0.015 in. of an external PVC. The extruded profile properties. Test samples were obtained and evaluated as shown below:

TABLE 6
Test Composites

| Component | Ex. 1 Wt. % | Ex. 2 Wt. % | | Ex. 4 Wt. % | |
|---|---|---|---|---|---|
| PVC | Balance | Balance | | Balance | |
| CPE | 0 wt. % | 2 | wt. % | 4 | wt. % |
| Glass fiber | 0 wt. % | 6 | wt. % | 12 | wt. % |
| Interfacial | n/a | 1.48 | wt. % | 1.48 | wt. % |
| Modifier on glass | | | | | |

### Testing Methods:

Testing methods are indicated in the tables of data for all tests except the heat distortion test that is done as follows:

In the heat distortion test, a length of extruded profile is placed in a thermostatically controlled chamber at a temperature of about 143° F. the length is supported at each end leaving an unsupported length of about 8 feet. Directly under the center of the supports profile is a laser inferometer that can measure the heat deflection of the profile in thousands of an inch over a fixed period typically 10-500 hours. The data is reported in hours needed to result in a deflection due to heat equal to the unsupported span length divided by 120.

TABLE 7
Composite Test Protocols

| Test | Metric | Method | Ex. 1 | Ex. 2 | Ex. 4 |
|---|---|---|---|---|---|
| COTE | In/in/° F. | D6341 | 3.2 × 10⁻⁵ | 2.2 × 10⁻⁵ | 1.7 × 10⁻⁵ |
| Room | In-lb-In⁻¹ | D4226 | 50 | 69 | 158 |
| Temp. | | | | | |
| Impact | | | | | |
| Flex | Mpsi | D790 | 39 | 40 | 40 |
| Modulus | | | | | |
| Heat | hrs. | As | 13 | 345 | 70 |
| Distortion | | described | | | |

### Detailed Discussion of FIG. 1

In FIG. 1 there is a drawing of a cross section of a horizontal rail support used in an external fencing system. In FIG. 1, there is a profile cross section 10 including a composite exterior wall of the profile comprising the composite as disclosed herein. Further in FIG. 1 is shown a series of walls within the composite profile. In profile 10 there is a reinforcing walls 14 a-c that cooperate with voids 11 a-c, providing structural integrity to the base portion 16 of the profile 10. Further, there is reinforcing walls 11 d-e further providing horizontal structural integrity to the profile. Further in FIG. 1 there are reinforcing walls 11 f and voids 12 a-b within the profile that cooperates and defines an insertion locus 15 for the vertical members in a wall fence system. Further in the FIG. 1 there is an internal void space 13 and 13a providing space defining the structural members of the structural members 11b-c of the profile. Reinforced base 16 comprises walls 11 a-c and voids 14 a-c

TABLE 8
FIG. 1 - Reference Numbers

| Reference | | |
|---|---|---|
| number | Component | Description |
| 10 | Composite profile | Fence rail profile |
| | member | |
| 11 | Outside wall of | Defines the dimensional parameters |
| | profile | of the profile |
| 11 a-e | Reinforcing walls | Reinforces the outside walls of the |
| | of profile | profile |
| 11 f | Reinforcing walls | Reinforces the slot of the profile |
| | of profile | |
| 12 a-b | Internal voids | Voids cooperates with walls 11f to |
| | | provide structural integrity to slot |
| 13 13a | Internal voids | Voids cooperates with walls to provide |
| | | structural integrity to profile |
| 14 a-c | Base voids | Voids cooperates with walls 11 a-c to |
| | | provide structural integrity to profile |
| 15 | Inset space | Insert slot support for upright fencing |
| | | member |
| 16 | Base structure | Base of member defined by walls 11 |
| | | a-c and voids 14 a-c |

The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

The specification shows an enabling disclosure of the composite technology, other embodiments may be made with the claimed materials. Accordingly, the invention is embodied solely in the claims hereinafter appended. The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

The specification shows an enabling disclosure of the composite technology, other embodiments may be made with the claimed materials.

We claim:

1. A thermoplastic composite masterbatch comprising a fiber phase and a polymer phase:
(a) the fiber phase comprising greater than 50 wt. % a glass fiber with a length greater than about 1 mm, a diameter greater than about 0.8 microns and an aspect ratio greater than about 10, the fiber having about 0.1 to 5 wt. % of an exterior coating comprising a mixture of organo metallic interfacial modifiers, the wt. % based on the fiber phase and;
(b) the polymer phase comprising a thermoplastic polymer comprising vinyl chloride and a chlorinated polyethylene (CPE) at a weight ratio of about 0.1 to 10 parts by weight of polymer per part of CPE;
wherein the master batch and a composite there\from has a COTE (D6341) of 0.5 to 1.5 in/in/° F., a room temperature impact resistance of about 200 to 1000 ft-lb-in⁻¹ (ASTM D256), a flexural modulus (ASTM D790) of about 0.4 to 3 Mpsi and a heat distortion of less than about 50 hrs. at 143° F.

2. The masterbatch of claim 1 comprising about 55 to 70 wt. % fiber phase dispersed in a about to 60 wt. % of a polymer phase.

3. The masterbatch of claim 1 comprising a glass fiber having a length of 1 to 20 mm, a diameter of 1-15-0 microns and an aspect ratio greater than 90.

4. The masterbatch of claim 1 comprising a PVC polymer.

5. The masterbatch of claim 4 comprising a PVC homo polymer.

6. The masterbatch of claim 1 comprising a CPE with 25 to 45 wt. chlorine.

7. The composite of claim 1 comprising fiber having about 0.5 to 3 wt. % of an exterior coating comprising a mixture of mixed interfacial modifiers, the wt. % based on the fiber phase.

8. A fence rail comprising a composite of the masterbatch of claim 1 comprising 3 to 10 wt. % CPE and 5 to 10 wt. % glass and a mixed organo metallic interfacial modifiers.

9. A fence rail comprising a composite of the masterbatch of claim 1 comprising 3 to 7 wt. % CPE and 3 to 7 wt. % glass and a mixed organo metallic interfacial modifiers.

10. A thermoplastic composite member comprising a fiber phase and a polymer phase:
(a) the fiber phase comprising about 1 to 20 wt. % of a glass fiber with a length greater than about 1 mm, a diameter greater than about 0.8 microns and an aspect ratio greater than about 10, the fiber having about 0.1 to 5 wt. % of an exterior coating comprising a mixture of organo metallic interfacial modifiers, the wt. % based on the fiber phase; and;
(b) the polymer phase comprising 80 to 99 wt. % of a thermoplastic polymer comprising vinyl chloride and a chlorinated polyethylene (CPE) at a weight ratio of about 0.1 to 50 parts by weight of CPE per 100 part of polymer;
wherein the composite has a COTE (D6341) of 1.0 to 3.0×10⁻⁵ in/in/° F., a room temperature impact resistance of about 100 to 500 ft-lb-in⁻¹ (ASTM D256), a flexural modulus (ASTM D790) of about 0.4-0.5 Mpsi and a heat distortion of more than 50 hours at 143° F.

11. The member of claim 10 comprising about 2 to 10 wt. % fiber phase dispersed in a about 90 to 98 wt. % of a polymer phase

12. The member of claim 10 comprising a glass fiber having a length of 1 to 20 mm, a diameter of 1-15-0 microns and an aspect ratio greater than 90.

13. The member of claim 10 comprising a PVC polymer.

14. The member of claim 12 comprising a PVC homo polymer.

15. The member of claim 10 comprising a CPE with 25 to 40 wt. chlorine.

16. The member of claim 10 comprising fiber having about 0.5 to 3 wt. % of an exterior coating comprising a mixed interfacial modifier, the wt. % based on the fiber phase.

17. The member of claim 10 comprising fiber having about 1 to 1.5 wt. % of an exterior coating comprising an interfacial modifier, the wt. % based on the fiber phase.

18. The member of claim 10 comprising an organo metallic interfacial modifier.

19. The member of claim 10 comprising a profile.
